(19) United States
(12) Patent Application Publication
(10) Pub. No.: US 2018/0181040 A1
(43) Pub. Date: Jun. 28, 2018

(54) RECORDING MEDIUM, IMAGE FORMING APPARATUS, AND GUIDE MEMBER

(71) Applicant: FUJI XEROX CO., LTD., Tokyo (JP)

(72) Inventors: Tsubasa NISHINO, Kanagawa (JP); Katsumi HARADA, Kanagawa (JP); Mikihiro MORI, Kanagawa (JP)

(73) Assignee: FUJI XEROX CO., LTD., Tokyo (JP)

(21) Appl. No.: 15/592,718

(22) Filed: May 11, 2017

(30) Foreign Application Priority Data
Dec. 22, 2016 (JP) 2016-249672

(51) Int. Cl. G03G 15/00

(52) U.S. Cl. CPC G03G 15/50

(57) ABSTRACT

A recording medium includes at least one memory. The at least one memory is provided at a position where the at least one memory is not to be brought into contact with at least one transport member included in at least one transport unit provided in a transport path of an image forming apparatus.

### CROSS-REFERENCE TO RELATED APPLICATIONS

This application is based on and claims priority under 35 USC 119 from Japanese Patent Application No. 2016-249672 filed Dec. 22, 2016.

### BACKGROUND

### Technical Field

The present invention relates to a recording medium, an image forming apparatus, and a guide member.

### SUMMARY

According to an aspect of the present invention, a recording medium includes at least one memory. The at least one memory is provided at a position where the at least one memory is not to be brought into contact with at least one transport member included in at least one transport unit provided in a transport path of an image forming apparatus.

### BRIEF DESCRIPTION OF THE DRAWINGS

Exemplary embodiments of the present invention will be described in detail based on the following figures, wherein:

FIG. 1 is a side sectional view of an image forming apparatus common to exemplary embodiments;

FIG. 2 is a plan view of a recording medium according to a first exemplary embodiment;

FIG. 3 is a sectional view of the recording medium according to the first exemplary embodiment;

FIG. 4 is a plan view illustrating transportation of the recording medium according to the first exemplary embodiment;

FIG. 5 is a plan view illustrating a comparative example and the recording medium according to the first exemplary embodiment;

FIG. 6 is a plan view of a recording medium according to a second exemplary embodiment;

FIG. 7 is a plan view illustrating transportation of the recording medium according to the second exemplary embodiment;

FIG. 8 is a plan view illustrating a comparative example and the recording medium according to the second exemplary embodiment;

FIG. 9A is a plan view of a first application of the recording medium according to the first exemplary embodiment, and FIG. 9B is a plan view of a second application of the recording medium according to the second exemplary embodiment;

FIG. 10 is a plan view illustrating transportation of a recording medium according to a third exemplary embodiment; and

FIG. 11 is a plan view illustrating transportation of a recording medium according to a fourth exemplary embodiment.

### DETAILED DESCRIPTION

Exemplary embodiments of the present invention will be described with reference to the drawings. It should be understood that the following exemplary embodiments describe examples of a recording medium, an image forming apparatus, and a guide member to embody the technical thought of the present invention and are not intended to specify the present invention. The present invention is equally adaptable to other embodiments included in the scope of the claims.

### A First Exemplary Embodiment

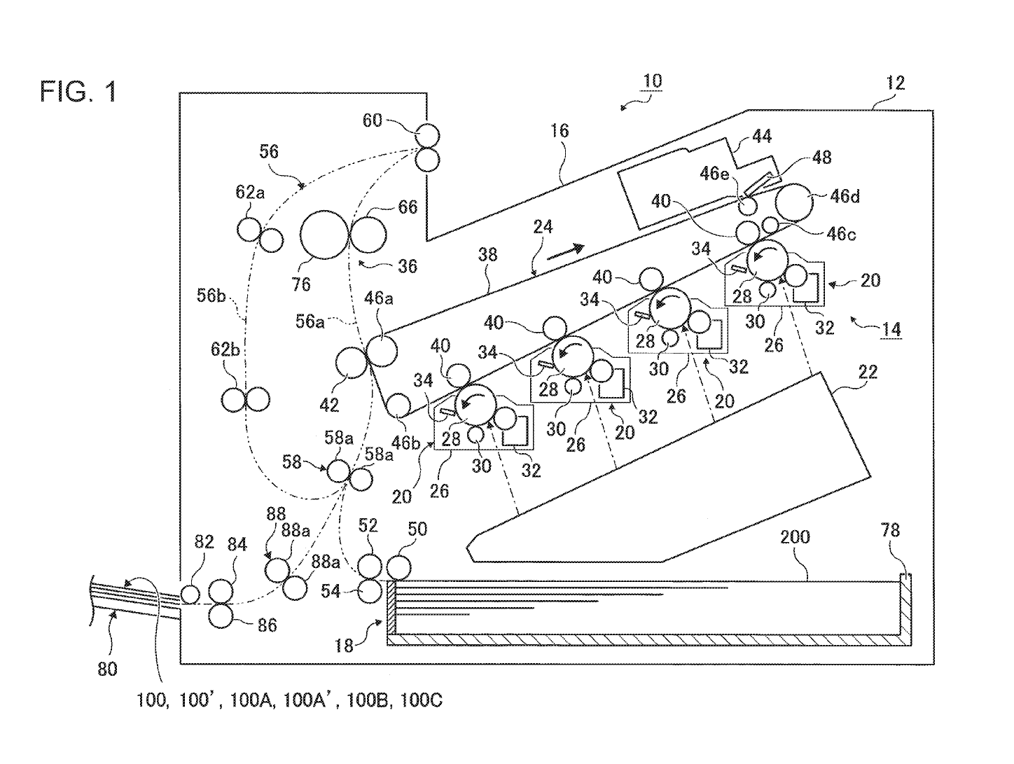

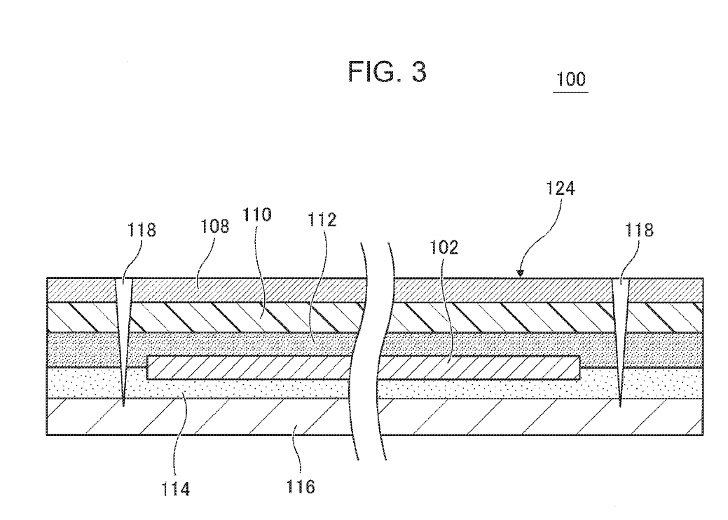

First, an image forming apparatus 10 and a recording medium 100 according to a first exemplary embodiment are described with reference to FIGS. 1 to 5. The image forming apparatus 10 according to the first exemplary embodiment includes, as illustrated in FIG. 1, an image forming apparatus body 12. The recording medium 100 according to the first exemplary embodiment is placed in a side surface (left side of FIG. 1) of the image forming apparatus body 12. The image forming apparatus 10 includes a manual feed unit 80 serving as an opening/closing device from which the recording medium 100 is fed into the image forming apparatus body 12. Furthermore, a sheet feed unit 18, an image forming section 14, and a fixing device 36 are disposed in the image forming apparatus body 12. The sheet feed unit 18 supplies a different recording medium 200 that is different from the recording medium 100 according to the first exemplary embodiment such as recording paper. The image forming section 14 forms images to be transferred to the recording medium 100 and the different recording medium 200. An output unit 16 is provided in an upper portion of the image forming apparatus body 12 to which the recording medium 100 and the different recording medium 200 are output. A transport path 56 are provided so as to allow the recording medium 100 and the different recording medium 200 to be transported therethrough so as to pass through these components (hereafter, the recording medium according to the first exemplary embodiment is simply referred to as “recording medium 100” and the recording medium different from the recording medium 100 according to the first exemplary embodiment is referred to as “different recording medium 200”. Furthermore, in some cases, the recording medium 100 and the different recording medium 200 are collectively referred to as “recording media 100 and 200”). Although the different recording medium 200 is able to be placed in the manual feed unit 80, it is assumed in the following description that the recording medium 100 according to the first exemplary embodiment is placed in the manual feed unit 80.

Furthermore, the manual feed unit 80 of the image forming apparatus body 12 is configured such that the recording medium 100 supplied from the manual feed unit 80 side is placed in the image forming apparatus body 12 when the manual feed unit 80 is open (see FIG. 1), and the manual feed unit 80 is retracted in the side surface of the image forming apparatus body 12 when the manual feed unit 80 is closed (not illustrated).

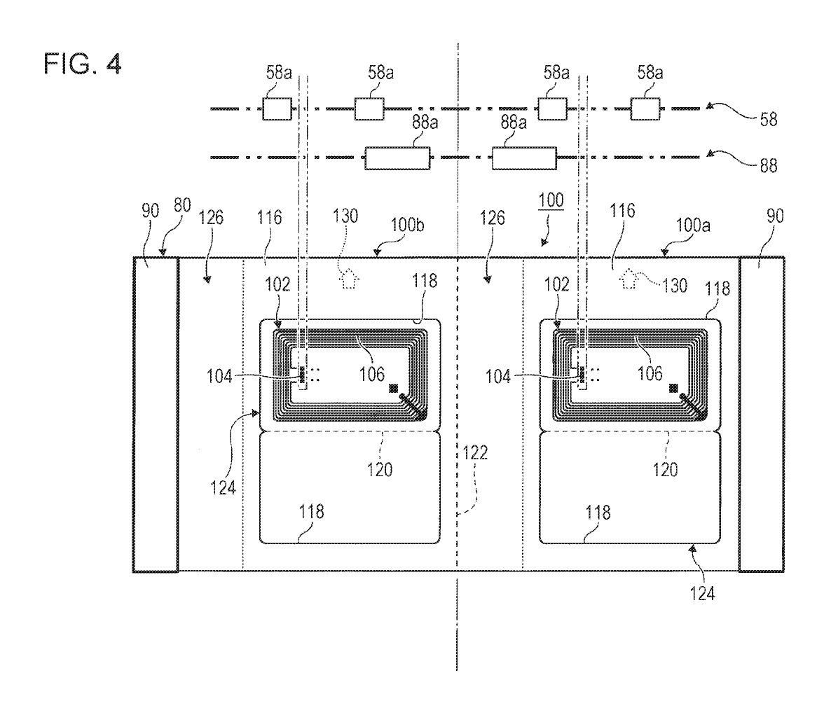

The manual feed unit 80 is provided with a pair of manual feed guides 90 (see FIG. 4). The manual feed guides 90 each serving as a guide are moved in accordance with the size of the recording medium 100, support the recording medium 100 such that both sides of the recording medium 100 in a direction perpendicular to the transport direction of the recording medium 100 are interposed between the guides, and causes the recording medium 100 to be placed such that a central position of the recording medium 100 in the transport direction is substantially aligned with a transport center position of the transport path 56 of the image forming apparatus body 12 which will be described later.

The following components are provided in the sheet feed unit 18: a sheet feed cassette 78 that contains different recording media 200 in a stacked state; a pickup roller 50 that picks up an uppermost different recording medium 200 out of the recording media 200 contained in the sheet feed cassette 78; a supply roller 52 that feeds the picked up different recording medium 200 toward the image forming section 14; and a retard roller 54 that separates a single different recording medium 200 from the different recording media 200 so as to prevent the plural recording media 200 superposed on one another from being transported to the image forming section 14.

The image forming section 14 includes, for example, image forming units 20, an optical drawing device 22, and a transfer device 24. Each of the image forming units 20 corresponds to a corresponding one of four colors that are, for example, yellow (Y), magenta (M), cyan (C), and black (K). The configurations of the image forming units 20 and these elements are the same as or similar to one another except for the colors formed by the image forming units 20 and these elements.

The image forming units 20 are replaceable members and detachably attached to the image forming apparatus body 12. The image forming units 20 are arranged in the order of Y, M, C, and K from the rear side (right side of FIG. 1) of the image forming apparatus body 12.

An electrophotographic method for forming, for example, color images is used for the image forming units 20. The image forming units 20 include respective image forming unit bodies 26. An image holding body 28, a charger 30, a developing device 32, and a cleaner 34 are provided in each of the image forming unit bodies 26. The image holding body 28 has a drum shape and holds a developer image. The charger 30 serving as a charging device includes a charging roller that uniformly charges the image holding body 28. The developing device 32 develops a latent image drawn on the image holding body 28 with developer (toner). The cleaner 34 cleans the image holding body 28 by, for example, scraping off waste developer remaining on the image holding body 28.

The developing device 32 each use developer of a corresponding one of the Y, M, C, and K colors contained therein so as to develop the latent image formed on a corresponding one of the image holding bodies 28.

Furthermore, the optical drawing device 22 is used as a latent image forming device that includes, for example, a scanning laser light exposure device so as to form latent images on the surfaces of the image holding bodies 28. An alternative embodiment of the optical drawing device 22 may include, for example, light emitting diodes (LEDs) or a plane emission laser.

The transfer device 24 includes a transfer target member 38, first transfer rollers 40, a second transfer roller 42, and a cleaner 44. The transfer target member 38 is used as a transfer body. The first transfer rollers 40 are used as first transfer devices. The second transfer roller 42 is used as a second transfer device.

The transfer target member 38 has, for example, an endless belt shape and is supported by five support rollers 46a, 46b, 46c, 46d, and 46e such that the transfer target member 38 is rotatable in an arrow direction illustrated in FIG. 1. Furthermore, at least one of the support rollers 46a, 46b, 46c, 46d, and 46e is connected to a motive power source (not illustrated) such as a motor and rotated by receiving drive transmitted from the motive power source, thereby the transfer target member 38 is rotated.

The support roller 46a faces the second transfer roller 42 and functions as a backup roller of the second transfer roller 42. A nip between the second transfer roller 42 and the support roller 46a is a second transfer position.

The first transfer rollers 40 transfer to the transfer target member 38 the developer images formed on the surfaces of the image holding bodies 28 by the respective developing devices 32.

Furthermore, the second transfer roller 42 transfers to the recording medium 100 or the different recording medium 200 the Y, M, C, and K developer images having been transferred to the transfer target member 38.

The cleaner 44 includes a scraping member 48 that scrapes off the developer of the colors remaining on the surface of the transfer target member 38 after the developer images of the colors have been transferred to the recording medium 100 or the different recording medium 200 by the second transfer roller 42. The developer having been scraped off by the scraping member 48 is collected in a body of the cleaner 44.

The transport path 56 includes a normal transport path 56a and an inversion transport path 56b.

The normal transport path 56a transports the recording medium 100 or the different recording medium 200 supplied from the manual feed unit 80 or the sheet feed unit 18 to the image forming section 14 and outputs the recording medium 100 or the different recording medium 200 on which an image has been formed to the output unit 16.

In the case of feeding the different recording medium 200 from the sheet feed unit 18 through the normal transport path 56a, the pickup roller 50, the supply roller 52, the retard roller 54, a registration roller unit 58, the transfer device 24, the fixing device 36, and an output roller 60 disposed in this order from an upstream side in the transport direction are used.

The pickup roller 50 feeds the different recording medium 200 from the sheet feed cassette 78 of the sheet feed unit 18. With the supply roller 52 and the retard roller 54, the different recording medium 200 is separated from another different recording medium 200 in the case where plural recording media 200 have been fed, and the separated recording medium 200 is introduced into the normal transport path 56a.

In the case of feeding the recording medium 100 from the manual feed unit 80 to the normal transport path 56a, the recording medium 100 is fed by a manual feed pickup roller 82 from the manual feed unit 80 disposed on the upstream side in the transport direction. With a manual feed supply roller 84 and a manual feed retard roller 86, the recording medium 100 is separated from another recording medium 100 in the case where plural recording media 100 have been fed, and the separated recording medium 100 is introduced into the normal transport path 56a by a transport roller unit 88.

As illustrated in FIG. 4, the transport roller unit 88 serving as one of transport devices has a smaller width than the size of the transport path in a width direction (simply referred to as “transport-path width” hereafter) perpendicular to the transport direction. The transport roller unit 88 includes rotatable transport members 88a. Regarding one and the other sides of the normal transport path 56a, at least one of the transport members 88a is provided on each of the sides of the normal transport path 56a. According to the first exemplary embodiment, two transport members 88a are provided on each side of the normal transport path 56a. the recording medium 100 to be transported is nipped between the transport members 88a of the transport roller unit 88 and transported when the transport members 88a are rotated.

Furthermore, a registration roller unit 58 serving as one of the transport devices temporarily stops a leading end portion of the recording medium 100 or 200 transported from the sheet feed unit 18 side and feeds the recording medium 100 or 200 toward the transfer device 24 at timing coincident with timing of image formation.

As illustrated in FIG. 4, the registration roller unit 58 has a smaller width than the transport-path width. The registration roller unit 58 includes rotatable transport members 58a. At least one of the transport members 58a is provided on each of the sides of the normal transport path 56a. According to the first exemplary embodiment, four transport members 58a are provided on each side of the normal transport path 56a. the recording medium 100 or 200 to be transported is nipped between the transport members 58a of the registration roller unit 58 and fed when the transport members 58a are rotated.

The fixing device 36 includes a heating roller 66 serving as a heating unit and a pressure unit 76. the recording medium 100 or 200 passing through a nip between the heating roller 66 and the pressure unit 76 is subjected to heat and pressure, thereby the developer images are fixed to the recording medium 100 or 200.

The output roller 60 outputs to the output unit 16 the recording medium 100 or 200 to which the developer has been fixed by the fixing device 36.

Furthermore, the different recording medium 200 on one side of which the developer image has been formed is supplied toward the image forming section 14 again while being inverted through the inversion transport path 56b. For example, two inversion transport rollers 62a and 62b are disposed along the inversion transport path 56b.

The different recording medium 200 is transported to the output roller 60 through the normal transport path 56a, and a trailing end portion of this different recording medium 200 is held at the output roller 60. In this state, the different recording medium 200 is supplied to the inversion transport path 56b by rotating the output roller 60 in a reverse direction. The different recording medium 200 supplied to the inversion transport path 56b is transported to a position upstream of the registration roller unit 58 by the inversion transport rollers 62a and 62b.

Although most of the description of the transport devices according to the first exemplary embodiment is about the transport roller unit 88 and the registration roller unit 58, the transport devices are not limited to these. The transport devices also include the manual feed pickup roller 82, the manual feed supply roller 84, the manual feed retard roller 86, and the output roller 60 disposed from the manual feed unit 80 side to the output side through the normal transport path 56a. Furthermore, the transport devices may also include the pickup roller 50, the supply roller 52, and the retard roller 54 on the sheet feed unit 18 side.

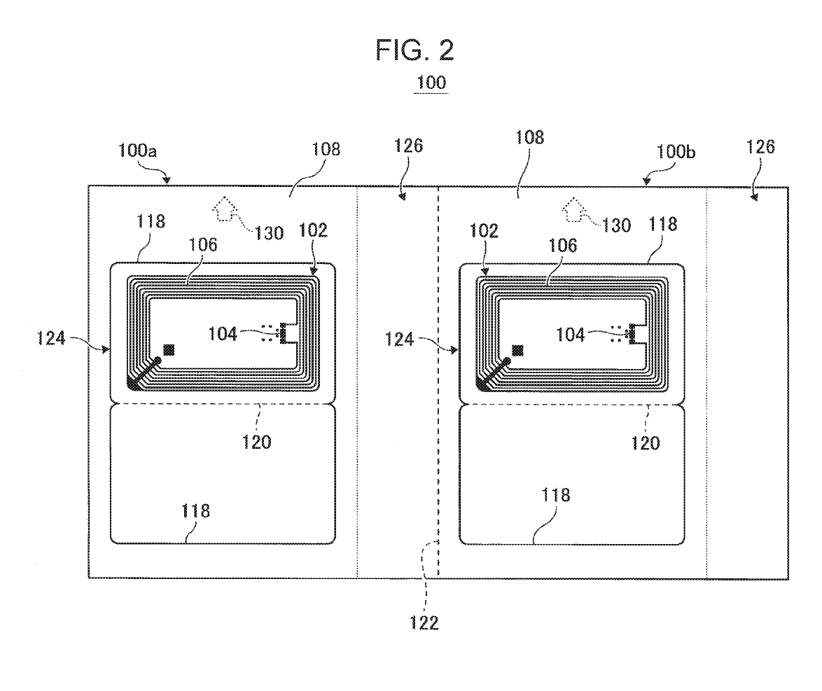

Next, the recording medium 100 according to a first exemplary embodiment is described with reference to FIGS. 2 to 5.

the recording medium 100 according to the first exemplary embodiment has a rectangular shape having a longitudinal side and a transverse side. the recording medium 100 includes the following layers on one side or the other side of, at least one, for example, two circuit devices 102. That is, on the one side of the recording medium 100, a first adhesive layer 112 serving as one base material, a base material layer 110 formed of, for example, a resin material, and a coating layer 108 on which an image is formed are disposed in this order from the circuit device 102 side. On the other side of the recording medium 100, a second adhesive layer 114 and release paper 116 are laminated in this order from the circuit device 102 side. The second adhesive layer 114 serves as the other base material. The release paper 116 serving as a release member has a surface to which the second adhesive layer 114 is applied and from which the second adhesive layer 114 is removable. In this state, the first adhesive layer 112 on the one side and the second adhesive layer 114 on the other side are bonded to each other with the circuit devices 102 interposed therebetween. Hereafter, in some cases, the coating layer 108 side is referred to as a front side and the release paper 116 side is referred to as a back side. It is noted that, for illustrative purposes, FIG. 2 is a cutaway view so as to allow the circuit devices 102 to be seen from the front side.

The image forming side of the recording medium is not limited to the configuration in which the coating layer is provided on the base material layer. A paper material or the like on which an image is able to be formed may be used.

Furthermore, each of the circuit devices 102 includes a memory 104 and a transceiver 106. The memory 104 includes a component such as an integrated circuit (IC) in which data such as various types of information and records is stored. The coil-shaped transceiver 106 is formed by winding plural metal wires which are connected to the memory 104 and through which the data is transmitted and received. The transceiver 106 also functions as a part that generates an electromotive force by receiving electric waves from another party.

Furthermore, cuts 118 are formed in the recording medium 100 according to the first exemplary embodiment so as to surround specified regions which includes the circuit devices 102. The cuts 118 extend from the coating layer 108 side on the one side of the recording medium 100 where an image is formed to the second adhesive layer 114 on the other side of the recording medium 100. There is no cut in the release paper 116. In this state, in the recording medium 100 according to the first exemplary embodiment, the cuts 118 having rectangular surrounding shapes are formed at two positions in a single recording medium 100. Portions surrounded by the cuts 118 are release portions 124 to be released. According to the first exemplary embodiment, the cuts 118 each have a rectangular shape the longitudinal direction of which is a direction of feeding the recording medium 100 into the image forming apparatus body 12.

Furthermore, a perforation 120 is formed at such a position that each of the release portions 124 surrounded by the cuts 118 is substantially equally divided into two halves in the transverse direction of the recording medium 100 by the perforation 120. In this state, the circuit device 102 is disposed on one of the halves of the release portion 124 divided by the perforation 120.

Furthermore, a space is provided between the release portions 124 surrounded by the cuts 118, and a vertical perforation 122 is provided between the release portions 124. This vertical perforation 122 extends in the transport direction at or near the center of the recording medium 100 in the longitudinal direction so as to substantially equally divide the recording medium 100 into two halves.

Furthermore, the memory 104 of the circuit device 102 provided in each of the release portions 124 of the recording medium 100 according to the first exemplary embodiment is provided at such a position where, when an image is formed on the recording medium 100 by the image forming apparatus 10, the memory 104 avoids and is prevented from being brought into contact with the transport devices that perform transportation in the image forming apparatus body 12. Examples of these transport devices include, for example, the transport members 88a and the transport members 58a provided in the transport roller unit 88 and the registration roller unit 58.

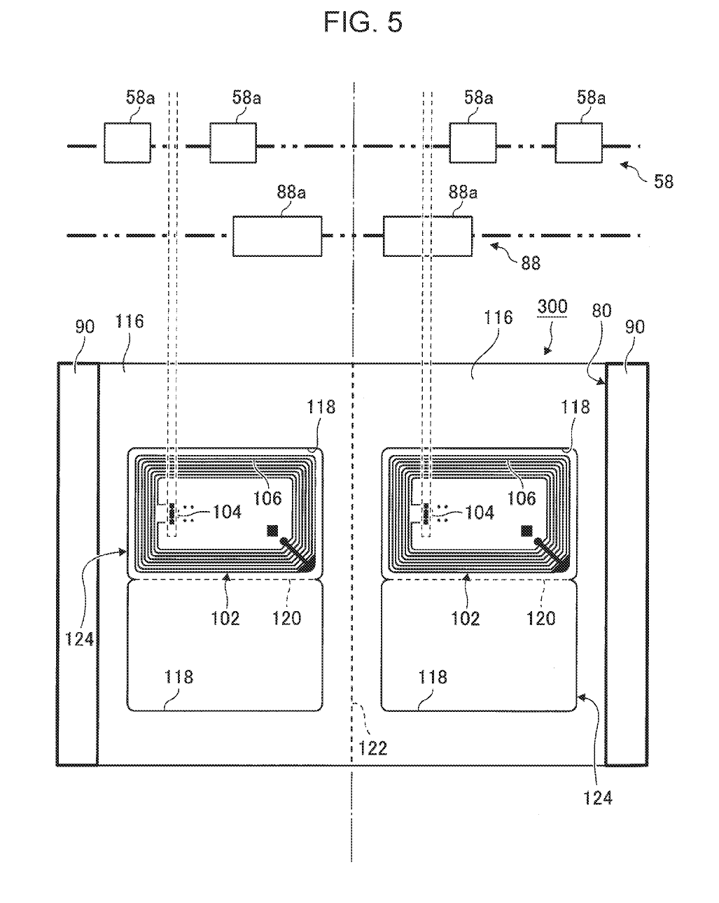

That is, while the recording medium 100 is transported through the transport path 56 in the image forming apparatus body 12 when an image is formed by the image forming apparatus 10, the recording medium 100 in which the circuit devices 102 are formed is pressed due to its passage through the nip between the transport members 88a of the transport roller unit 88 and the nip between the transport members 58a of the registration roller unit 58. Large pressing forces received by the recording medium 100 at this time may cause problems in the memories 104 of the circuit devices 102 such as damage to the memories 104 and the like. For example, no wide portion 126 to be described later is provided in a recording medium 300 illustrated in FIG. 5, and accordingly, the memories 104 are disposed at positions where the memories 104 are to be brought into contact with the transport members 88a of the transport roller unit 88 as one of the transport devices. Thus, the memories 104 are pressed by the transport members 88a, and accordingly, problems may occur in the memories 104.

Thus, in order to prevent problems of the memories 104 of the recording medium 100 from occurring, the recording medium 100 according to the first exemplary embodiment is disposed at a position where the memories 104 are to avoid and are not to be brought into contact with the transport devices, that is, according to the first exemplary embodiment, the transport members 88a and 58a of the transport roller unit 88 and the registration roller unit 58, which will be described later.

According to the first exemplary embodiment, regarding the positions in the recording medium 100 where the memories 104 are provided, the memories 104 are to avoid the transport members 88a and 58a by adjusting positions where the release portions 124 in which the circuit devices 102 are provided are formed in the recording medium 100.

First, in the recording medium 100 according to the first exemplary embodiment, the memories 104 are each provided on the left side in a corresponding one of the release portions 124 relative to a central portion of the release portion 124 when seen from the front side as illustrated in FIG. 2.

When the recording medium 100 is divided into a one recording medium 100a on the left side of the vertical perforation 122 of the recording medium 100 and another recording medium 100b on the right side of the vertical perforation 122 of the recording medium 100 seen from the front side as illustrated in FIG. 2, the release portions 124 of the one recording medium 100a and the other recording medium 100b are shifted to the left from central portions of the one recording medium 100a and the other recording medium 100b. That is, the one recording medium 100a and the other recording medium 100b have the same configuration in the recording medium 100 according to the first exemplary embodiment.

Accordingly, in the one recording medium 100a, a wide portion 126 as a margin having a specified area is provided further to the right than the release portion 124, that is, on the vertical perforation 122 side. Furthermore, in the other recording medium 100b, another wide portion 126 as a margin having substantially the same area as that of the wide portion 126 formed in the one recording medium 100a is provided further to the right than the release portion 124, that is, on the opposite side to the vertical perforation 122.

Yet another wide portion 126 having predetermined area extends in the perpendicular direction to the transport direction of the recording medium 100. In this case, the wide portion 126 is provided on a side opposite to the memories 104 with parts of the cuts 118 on a side where the distance between the cuts 118 and the memories 104 is small interposed therebetween. At this time, the area of this wide portion 126 is larger than that of a region extending in the perpendicular direction to the transport direction on a side opposite to the memories 104 with parts of the cuts 118 on a side where the distance between the cuts 118 and the memories 104 is large interposed therebetween.

Furthermore, the wide portion 126 is interposed between the manual feed guides 90 of the manual feed unit 80 so as to be supported when the recording medium 100 is transported into the image forming apparatus body 12 after the recording medium 100 has been placed in the manual feed unit 80. In this way, the positions of the memories 104 transported through the transport path 56 are adjusted. According to the first exemplary embodiment, this adjustment is made so that the vertical perforation 122 at the substantially central portion when seen in the transport direction of the recording medium 100 is substantially aligned with a transport central position of the transport path 56 (see FIG. 4).

Furthermore, in the recording medium 100 according to the first exemplary embodiment, specific positions where the memories 104 are provided are positions where the memories 104 are brought into contact with, for example, neither the transport members 88a of the transport roller unit 88 nor the transport members 58a of the registration roller unit 58 out of the transport devices when the recording medium 100 is transported through the transport path 56 of the image forming apparatus 10. The transport members 88a and 58a are disposed at positions where the memories 104 of the recording medium 100 do not pass when the recording medium 100 is transported.

In the description of the first exemplary embodiment, the transport roller unit 88 and the registration roller unit 58 are described as the transport devices required to avoid contact with the memories 104 of the recording medium 100. The reason for this is that, in the transport devices of the image forming apparatus body 12, pressing forces to nip the recording medium 100 are large (for example, a pressing force of more than 10.0 kgf) when the recording medium 100 is transported, and accordingly, problems such as damage to the nipped memories 104 and breakage of circuit wiring for connection to the memories 104 may occur.

Next, transportation of the recording medium 100 with the image forming apparatus 10 according to a first exemplary embodiment is described with reference to FIGS. 1, 4, and so forth. As described above, the recording medium 100 according to the first exemplary embodiment is provided with the circuit devices 102. The memories 104 are provided in the circuit devices 102 such that the memories 104 are to be brought into contact with neither the transport members 88a of the transport roller unit 88 nor the transport members 58a of the registration roller unit 58 of the normal transport path 56a of the image forming apparatus body 12.

Furthermore, as described above, the plural transport members 88a of the transport roller unit 88 are spaced from each other by a specified gap therebetween and the plural transport members 58a of the registration roller unit 58 are spaced from each other by a specified gap therebetween as illustrated in FIG. 4.

Specifically, the transport roller unit 88 is separated by a specified distance at a substantially central portion when seen in the transport direction. One and the other transport members 88a are disposed on one side and the other side of the central portion when seen in the transport direction of the recording medium 100, and a total of four transport members 88a are disposed such that the transport path 56 is interposed between two transport members 88a and two transport members 88a.

Specifically, the registration roller unit 58 is separated by a specified distance at a substantially central portion in a direction facing the transport direction. Two transport members 58a separated from each other by a specified distance are disposed on each side of the central portion in a direction facing the transport direction of the recording medium 100, and a total of eight transport members 88a are disposed such that the transport path 56 is interposed between four transport members 58a and four transport members 58a.

Furthermore, the memories 104 of the recording medium 100 are provided at such positions where the memories 104 are brought into contact with neither the transport members 88a of the transport roller unit 88 nor the transport members 58a of the registration roller unit 58 when transported through the transport path 56. That is, the transport members 88a and 58a are brought into contact with portions of the recording medium 100 where the memories 104 are not provided.

In order to form an image on the recording medium 100 according to the first exemplary embodiment with the image forming apparatus 10, first, the recording medium 100 is placed in the manual feed unit 80. The recording medium 100 is placed in the manual feed unit 80 as follows: the manual feed guides 90 of the manual feed unit 80 are moved so that both the sides of the recording medium 100 are supported by the manual feed guides 90 so as to substantially align the central position of the recording medium 100 with the transport central position of the transport path 56. The transport central position may be set at the central position of the transport roller unit 88 and the registration roller unit 58.

Furthermore, the recording medium 100 is placed in such a direction that the release paper 116 faces upward and the coating layer 108 of the recording medium 100 where the image is formed faces downward, that is, the manual feed unit 80 side. At this time, since the coating layer 108 of the recording medium 100 is disposed on the lower side, the cuts 118 formed in the recording medium 100 also face downward.

Accordingly, as illustrated in FIG. 4, the recording medium 100 to be fed into the transport path 56 is inverted from a state illustrated in FIG. 2.

At this time, the memories 104 of the circuit devices 102 provided in the recording medium 100 according to the first exemplary embodiment are disposed at positions where the memories 104 are to be brought into contact with neither the transport members 88a of the transport roller unit 88 nor the transport members 58a of the registration roller unit 58 that would otherwise apply a larger pressing force to the memories 104 and so forth in the normal transport path 56a.

Furthermore, the recording medium 100 according to the first exemplary embodiment is transported in such a direction that the side of each of the release portions 124 near the memory 104 is disposed on the transport path 56 side. However, this is not limiting. The side of the release portion 124 far from the memory 104 may be disposed on the transport path 56 side. In either case, the memories 104 of the recording medium 100 are disposed at positions where the memories 104 are to be brought into contact with neither the transport members 88a of the transport roller unit 88 nor the transport members 58a of the registration roller unit 58.

Furthermore, in order to specify the transport direction of the recording medium 100, marks 130 such as arrows may be provided. Since the coating layer 108 where the image is formed faces downward in the manual feed unit 80, the marks 130 are formed on the surface of the release paper 116 side, which is the opposite side of the recording medium 100 to the coating layer 108 where the image is formed.

The recording medium 100 having been placed in the manual feed unit 80 is fed from the manual feed unit 80 into the image forming apparatus body 12. Due to this feeding, the recording medium 100 is fed by the manual feed pickup roller 82. Then, the recording medium 100 is separated from another recording medium 100 by the manual feed supply roller 84 and the manual feed retard roller 86 in the case where plural recording media 100 have been fed. Then, the recording medium 100 is introduced into the normal transport path 56a by the transport roller unit 88.

At this time, the memories 104 of the recording medium 100 pass through without being brought into contact with the transport members 88a of the transport roller unit 88. That is, as illustrated in FIG. 4, in the transport roller unit 88 of the normal transport path 56a, the positions where the memories 104 of the recording medium 100 are provided pass through the outer sides relative to the transport roller unit 88, that is, opposite sides to the transport central position relative to the transport members 88a of the transport roller unit 88.

Furthermore, the leading end portion of the recording medium 100 having been introduced into the normal transport path 56a is temporarily stopped by the registration roller unit 58, and the recording medium 100 is fed toward the transfer device 24 at timing coincident with timing of image formation.

At this time, the memories 104 of the recording medium 100 pass through without being brought into contact with the transport members 58a of the registration roller unit 58. That is, as illustrated in FIG. 4, in the registration roller unit 58 of the normal transport path 56a, the positions where the memories 104 of the recording medium 100 are provided pass through portions between the transport members 58a of the registration roller unit 58.

Then, the image is formed on the recording medium 100 as described above, and after that, the recording medium 100 is output to the output unit 16. Thus, image formation is completed.

From the above description, according to the first exemplary embodiment, due to the existence of the wide portions 126 in the recording medium 100, it is possible to provide the memories 104 at the positions where the memories 104 are to be brought into contact with neither the transport members 88a of the transport roller unit 88 nor the transport members 58a of the registration roller unit 58 of the normal transport path 56a. Thus, problems such as damage to the memories 104 and the like may be prevented.

According to the first exemplary embodiment, the memories 104 of the recording medium 100 are provided at the positions where the memories 104 are to be brought into contact with neither the transport members 88a of the transport roller unit 88 nor the transport members 58a of the registration roller unit 58. However, this is not limiting. The memories 104 may be provided at positions where the memories 104 are not to be brought into contact with all or some of the transport members included in, for example, the manual feed pickup roller 82, the manual feed supply roller 84, the manual feed retard roller 86, and the output roller 60. Pressing forces applied by these are smaller than the pressing forces applied by the transport roller unit 88 and the registration roller unit 58 and are unlikely to cause problems in the memories 104 even when the memories 104 are pressed. However, with a configuration in which these transport members are not to be brought into contact with the memories 104, the occurrences of problems in the memories 104 may be further prevented.

Furthermore, according to the first exemplary embodiment, the memories 104 are brought into contact with neither the transport roller unit 88 nor the registration roller unit 58 because the transport roller unit 88 and the registration roller unit 58 each apply the pressing force of more than 10.0 kgf with which problems occur in the memories 104 of the recording medium 100. However, this is not limiting. The memories 104 may be configured such that the memories 104 are not brought into contact with a transport member of a transport device that applies a pressing force with which problems may occur.

### A Second Exemplary Embodiment

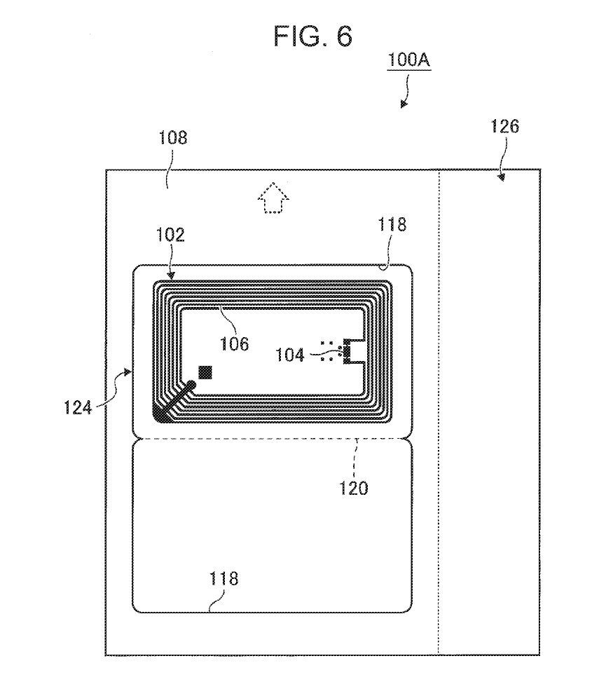

Next, the image forming apparatus 10 and a recording medium 100A according to a second exemplary embodiment are described with reference to FIGS. 1 and 6 to 8. As illustrated in FIG. 2, two release portions 124 provided with the circuit devices 102 are formed in a single recording medium 100 according to the first exemplary embodiment. In the recording medium 100A according to the second exemplary embodiment, a single release portion 124 is formed in a single recording medium 100A as illustrated in FIG. 6. It is noted that elements of the image forming apparatus 10 and the recording medium 100A according to the second exemplary embodiment which are the same as or similar to those of the image forming apparatus 10 and the recording medium 100 according to the first exemplary embodiment are denoted by the same reference numerals, and detailed description thereof is omitted.

As illustrated in FIG. 6, the recording medium 100A according to the second exemplary embodiment has the same configuration as one of the one recording medium 100a and the other recording medium 100b disposed on one and the other sides of the recording medium 100 according to the first exemplary embodiment with the vertical perforation 122 interposed therebetween. That is, the recording medium 100A according to the second exemplary embodiment is one of two recording media, that is, the one recording medium 100a and the other recording medium 100b of the recording medium 100 according to the first exemplary embodiment separated from each other by the vertical perforation 122. Thus, the recording medium 100A according to the second exemplary embodiment and, for example, the one recording medium 100a of the recording medium 100 according to the first exemplary embodiment have the same or similar configuration. Detailed description of the recording medium 100A according to the second exemplary embodiment is omitted.

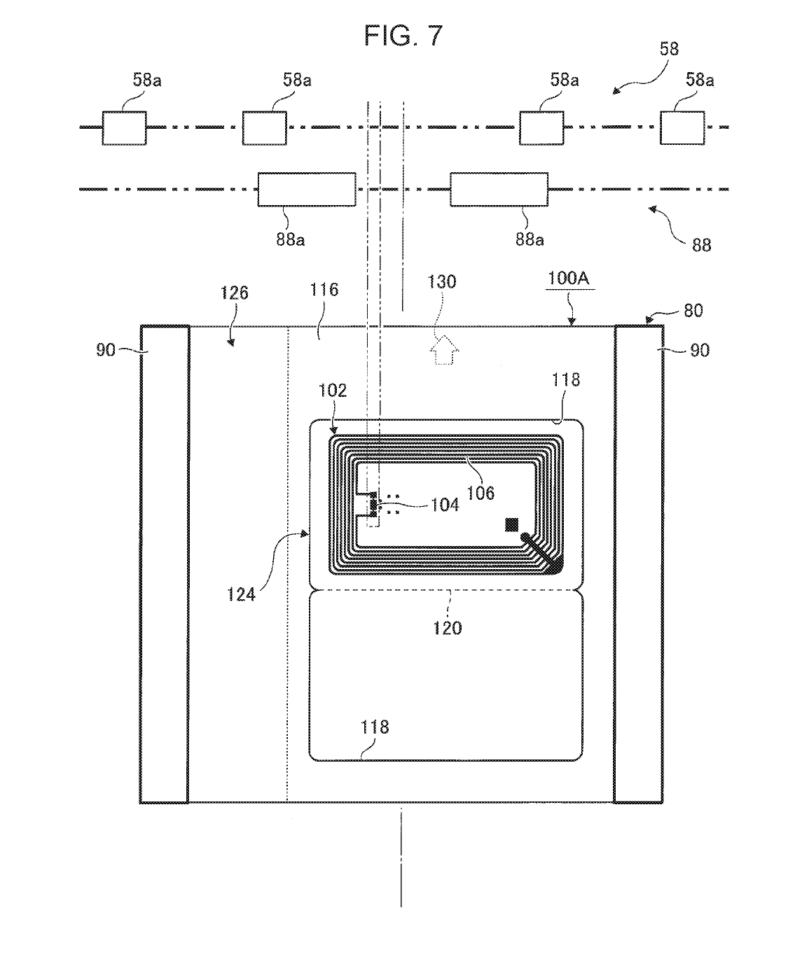

Next, transportation of the recording medium 100A according to the second exemplary embodiment with the image forming apparatus 10 is described with reference to FIGS. 1, 7, and so forth. Since the image forming apparatus 10 according to the second exemplary embodiment is the same as or similar to the image forming apparatus 10 according the first exemplary embodiment, detailed description thereof is omitted.

Furthermore, as described above, the entire size of the recording medium 100A according to the second exemplary embodiment is reduced compared to that of the recording medium 100 according to the first exemplary embodiment. Accordingly, the position where the memory 104 of the recording medium 100A according to the second exemplary embodiment passes through the transport path 56 of the image forming apparatus body 12 is different from the positions where the memories 104 of the recording medium 100 according to the first exemplary embodiment pass through the transport path 56 of the image forming apparatus body 12 (see FIGS. 4 and 7).

However, a wide portion 126 is provided on the side where the memory 104 of the release portion 124 is formed, and accordingly, when the recording medium 100A according to the second exemplary embodiment is placed in the manual feed unit 80, the memory 104 is disposed at a substantially central portion while the recording medium 100A is supported by the manual feed guides 90 (see FIG. 7).

In order to form an image on the recording medium 100A according to the second exemplary embodiment with the image forming apparatus 10, as is the case with the first exemplary embodiment, the recording medium 100A is placed in the manual feed unit 80. The recording medium 100A is placed in the manual feed unit 80 as follows: the manual feed guides 90 of the manual feed unit 80 are moved so that both the sides of the recording medium 100A are supported by the manual feed guides 90 so as to substantially align the central position of the recording medium 100A with the transport central position of the transport path 56 (see FIG. 7).

Furthermore, the orientation and the direction in which the recording medium 100A is placed is the same as or similar to that according to the first exemplary embodiment. That is, the memory 104 of the circuit device 102 provided in the recording medium 100A according to the second exemplary embodiment is disposed at positions where the memory 104 is to be brought into contact with neither the transport members 88a of the transport roller unit 88 nor the transport members 58a of the registration roller unit 58 that would otherwise apply a larger pressing force to the memory 104 and so forth in the transport path 56.

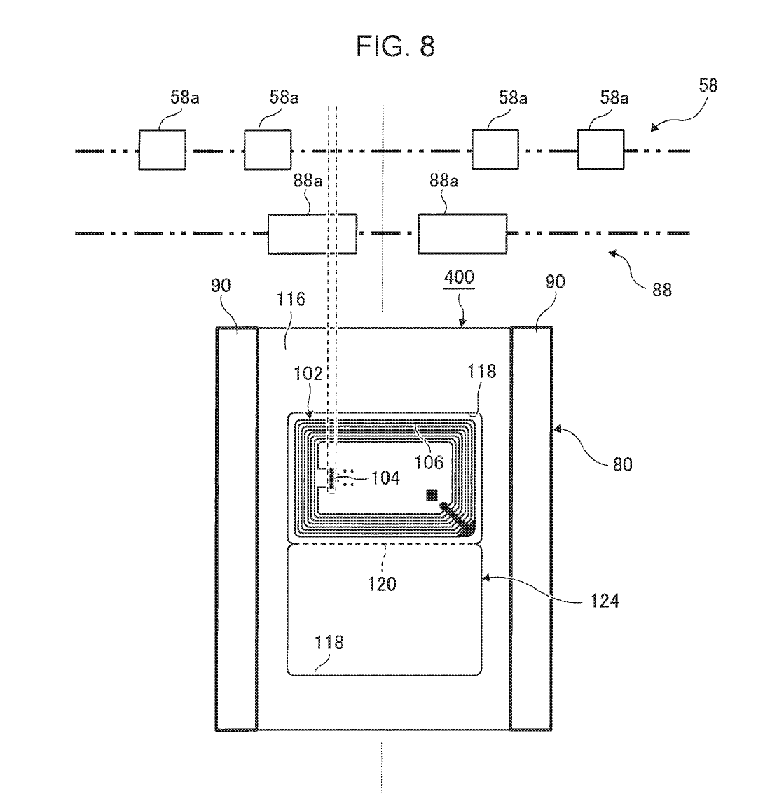

That is, as is the case with the recording medium 100 according to the first exemplary embodiment, while the recording medium 100A according to the second exemplary embodiment in which the circuit device 102 is formed is transported through the transport path 56 in the image forming apparatus body 12 when an image is formed by the image forming apparatus 10, the recording medium 100A is pressed due to its passage through the nip between the transport members 88a of the transport roller unit 88 and the nip between the transport members 58a of the registration roller unit 58. Large pressing forces received by the recording medium 100A at this time may cause problems in the memory 104 of the circuit device 102 such as damage to the memory 104 and the like. For example, when a recording medium 400 without wide portion 126 as illustrated in FIG. 8 is used, the memory 104 is disposed at a position where the memory 104 is partially to be brought into contact with the transport members 88a of the transport roller unit 88 as one of the transport devices. Thus, the memory 104 is pressed by the transport members 88a, and accordingly, problems may occur in the memory 104.

Thus, also in the recording medium 100A according to the second exemplary embodiment, in order to prevent problems of the memory 104 of the recording medium 100A from occurring, the memory 104 is disposed at a position where the memory 104 is to avoid the transport members 88a of the transport roller unit 88 and the transport members 58a of the registration roller unit 58 and is not to be brought into contact with the transport members 88a of the transport roller unit 88 or the transport members 58a of the registration roller unit 58.

Furthermore, the recording medium 100A having been placed in the manual feed unit 80 is fed from the manual feed unit 80 into the image forming apparatus body 12. Due to this feeding, the recording medium 100A is fed by the manual feed pickup roller 82. Then, the recording medium 100A is separated from another recording medium 100A by the manual feed supply roller 84 and the manual feed retard roller 86 in the case where plural recording media 100A have been fed. Then, the recording medium 100A is introduced into the normal transport path 56a by the transport roller unit 88.

At this time, the memory 104 of the recording medium 100A passes through without being brought into contact with the transport members 88a of the transport roller unit 88. That is, as illustrated in FIG. 7, in the transport roller unit 88 of the normal transport path 56a, the position where the memory 104 of the recording medium 100A is provided passes through a space between the transport members 88a at the central portion of the transport roller unit 88.

Furthermore, the leading end portion of the recording medium 100A having been introduced into the normal transport path 56a is temporarily stopped by the registration roller unit 58, and the recording medium 100A is fed toward the transfer device 24 at timing coincident with timing of image formation.

At this time, the memory 104 of the recording medium 100A passes through without being brought into contact with the transport members 58a of the registration roller unit 58. That is, as illustrated in FIG. 7, in the registration roller unit 58 of the normal transport path 56a, the position where the memory 104 of the recording medium 100A is provided passes through a space between the transport members 58a at a central portion of the registration roller unit 58.

Then, the image is formed on the recording medium 100A as described above, and after that, the recording medium 100A is output to the output unit 16. Thus, image formation is completed.

From the above description, according to the second exemplary embodiment, due to the existence of the wide portion 126 in the recording medium 100A, the memory 104 is provided at the position where the memory 104 is to be brought into contact with neither the transport members 88a of the transport roller unit 88 nor the transport members 58a of the registration roller unit 58 of the normal transport path 56a. Thus, problems such as damage to the memories 104 and the like may be prevented.

Also according to the second exemplary embodiment, the memory 104 of the recording medium 100A is provided at the position where the memory 104 is to be brought into contact with neither the transport members 88a of the transport roller unit 88 nor the transport members 58a of the registration roller unit 58. However, this is not limiting. The memory 104 may be provided at a position where the memory 104 is not to be brought into contact with all or some of the transport members included in, for example, the manual feed pickup roller 82, the manual feed supply roller 84, the manual feed retard roller 86, and the output roller 60.

### First and Second Applications

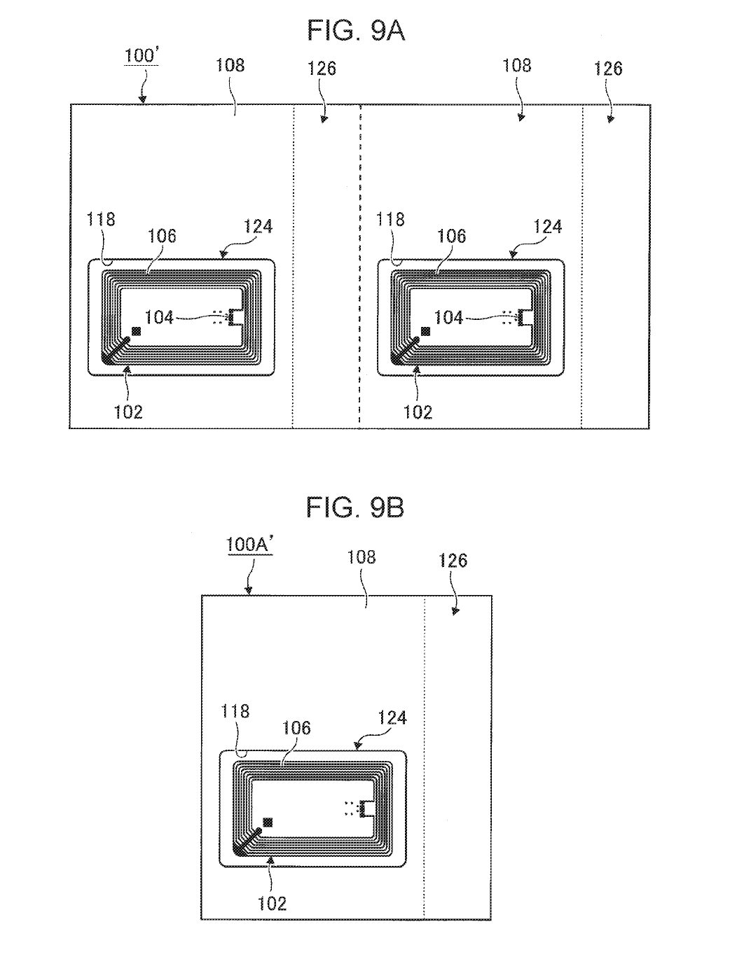

Although the release portion 124 includes a portion where the circuit device 102 is formed and a portion where the circuit device 102 is not formed in the recording media 100 and 100A according to the first and second exemplary embodiments (see FIGS. 2 and 6), this is not limiting. As is the case with a recording medium 100′ of a first application illustrated in FIG. 9A or a recording medium 100A′ of a second application illustrated in FIG. 9B, each of the release portions 124 of the recording media 100′ and 100A′ may include only the portion where the circuit device 102 is formed.

That is, as illustrated in FIG. 9A, a single recording medium 100′ of the first application includes, as is the case with the recording medium 100 according to the first exemplary embodiment, two circuit devices 102 including the respective memories 104, and the release portions 124 include only the portions where the circuit devices 102 are formed.

Furthermore, as illustrated in FIG. 9B, a single recording medium 100A′ of the second application includes, as is the case with the recording medium 100A according to the second exemplary embodiment, a single circuit devices 102 including the memory 104, and the release portion 124 includes only the portion where the circuit device 102 is formed.

Also the recording media 100′ and 100A′ of the first and second applications are provided with the larger width portions 126. This allows the memories 104 formed in the circuit devices 102 to be disposed at positions where contact of the memories 104 of the recording media 100′ and 100A′ with the transport members 88a of the transport roller unit 88 and the transport members 58a of the registration roller unit 58 is avoidable as is the case with the first or second exemplary embodiment. Accordingly, problems of the memories may be prevented.

### A Third Exemplary Embodiment

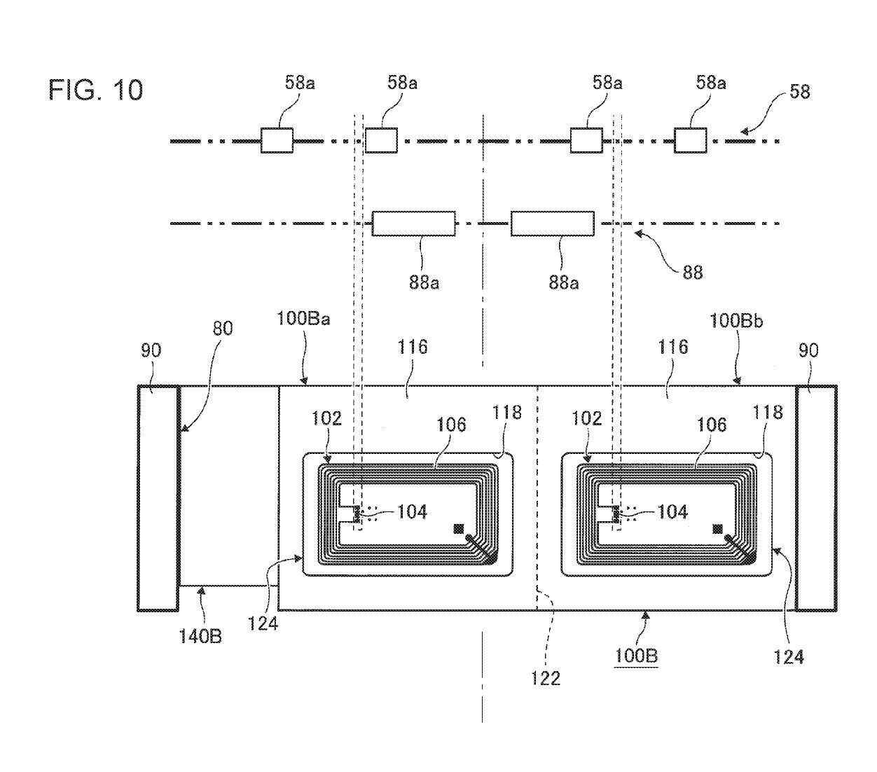

Next, the image forming apparatus 10, a recording medium 100B, and a guide member 140B according to a third exemplary embodiment are described with reference to FIGS. 1, 10, and so forth. As illustrated in FIG. 4, according to the first exemplary embodiment, the memories 104 of the recording medium 100 are transported at positions where the memories 104 are brought into contact with neither the transport members 88a of the transport roller unit 88 nor the transport members 58a of the registration roller unit 58 of the normal transport path 56a in the image forming apparatus body 12. In order to realize this, the wide portion 126 is provided in the recording medium 100 so as to allow the transport position to be adjusted when the recording medium 100 is placed in the manual feed unit 80. In contrast, as illustrated in FIG. 10, no wide portion 126 is provided in the recording medium 100B according to the third exemplary embodiment. Instead, the guide member 140B is provided so as to, when the recording medium 100B is placed in the manual feed unit 80 of the image forming apparatus body 12, allow the position where the recording medium 100B is placed to be adjusted so that the memories 104 are to be brought into contact with neither the transport members 88a of the transport roller unit 88 nor the transport members 58a of the registration roller unit 58 of the normal transport path 56a. This configuration is described below.

It is noted that elements of the image forming apparatus 10 and the recording medium 100B according to the third exemplary embodiment which are the same as or similar to those of the image forming apparatus 10 and the recording medium 100 according to the first exemplary embodiment are denoted by the same reference numerals, and detailed description thereof is omitted.

As illustrated in FIG. 10, the recording medium 100B according to the third exemplary embodiment is configured similarly to the recording medium 100 according to the first exemplary embodiment. However, unlike the recording medium 100 according to the first exemplary embodiment, no wide portion 126 is provided in the recording medium 100B and the size of the longitudinal side of the recording medium 100B is reduced compared to that of the recording medium 100 according to the first exemplary embodiment. That is, compared to the recording medium 100 according to the first exemplary embodiment, the distance between the cut 118 on the one recording medium 100a side and the vertical perforation 122 and the distance between the cut 118 on the one recording medium 100a side and part of the cut 118 on the opposite side to the vertical perforation 122 in the other recording medium 100b are reduced. Furthermore, as is the case with the recording medium 100′ of the first application of the first exemplary embodiment, the release portions 124 of the recording medium 100B according to the third exemplary embodiment include only the portions where the circuit devices 102 are provided. Other elements of the recording medium 100B according to the third exemplary embodiment are the same as or similar to those of the recording medium 100 according the first exemplary embodiment, and detailed description thereof is omitted.

Thus, when the recording medium 100B according to the third exemplary embodiment is placed in the manual feed unit 80, supported by the manual feed guides 90, and transported with the central position of the recording medium 100B substantially aligned with the transport central position of the transport path 56 in the same manner as or a similar manner to that of the first exemplary embodiment, the memories 104 of the recording medium 100B pass through positions where the memories 104 are pressed by either the transport members 88a of the transport roller unit 88 or the transport members 58a of the registration roller unit 58. This may cause problems in the memories 104.

In order to address this, according to the third exemplary embodiment, when the recording medium 100B is placed in the manual feed unit 80, the guide member 140B is also placed together with the recording medium 100B beside the recording medium 100B. When the recording medium 100B and the guide member 140B are interposed between and supported by the manual feed guides 90, the central position of the recording medium 100B is out of alignment from the transport central position of the transport path 56. This allows the memories 104 to be disposed at positions where the memories 104 are to be brought into contact with neither the transport members 88a of the transport roller unit 88 nor the transport members 58a of the registration roller unit 58 of the normal transport path 56a.

This guide member 140B has a predetermined width and is formed by a substantially rectangular parallelepiped block having a size that allows the recording medium 100B to be disposed at a position where the memories 104 of the recording medium 100B are to be brought into contact with neither the transport members 88a of the transport roller unit 88 nor the transport members 58a of the registration roller unit 58 of the transport path 56 (see FIG. 10).

In order to form an image on the recording medium 100B according to the third exemplary embodiment with the image forming apparatus 10, first, the recording medium 100B is placed in the manual feed unit 80. The guide member 140B and the recording medium 100B are disposed as follows: the guide member 140B is in contact with and supported by one of the manual feed guides 90 of the manual feed unit 80 which is located on the left side as illustrated in FIG. 10 according to the third exemplary embodiment; and the recording medium 100B is in contact with and supported by the other manual feed guide 90.

This is for disposing the memories 104 of the recording medium 100B according to the third exemplary embodiment such that the memories 104 are to be brought into contact with neither the transport members 88a of the transport roller unit 88 nor the transport members 58a of the registration roller unit 58. When the guide member 140B and the recording medium 100B are disposed on the opposite sides of the manual feed unit 80 to the respective sides described above, the memories 104 of the recording medium 100B may be brought into contact with the transport members 88a of the transport roller unit 88 or the transport members 58a of the registration roller unit 58. Furthermore, at this time, the central position of the recording medium 100B (vertical perforation 122) is not aligned with the transport central position of the transport path 56.

Furthermore, in order to clarify the orientation and the direction of transportation of the recording medium 100B, marks 130 such as arrows may be provided. Since the coating layer 108 where the image is formed faces downward in the manual feed unit 80, the marks 130 are formed on the surface of the release paper 116 side, which is the opposite side of the recording medium 100B to the coating layer 108 where the image is formed.

Furthermore, as is the case with the recording medium 100 according to the first exemplary embodiment, the recording medium 100B having been placed in the manual feed unit 80 is fed from the manual feed unit 80 into the image forming apparatus body 12. Due to this feeding, the recording medium 100B is fed by the manual feed pickup roller 82. Then, the recording medium 100B is separated from another recording medium 100B by the manual feed supply roller 84 and the manual feed retard roller 86 in the case where plural recording media 100B have been fed. Then, the recording medium 100B is introduced into the normal transport path 56a by the transport roller unit 88.

At this time, the memories 104 of the recording medium 100B pass through without being brought into contact with the transport members 88a of the transport roller unit 88. That is, as illustrated in FIG. 10, in the transport roller unit 88 of the normal transport path 56a, the positions where the memories 104 of the recording medium 100B are provided pass through the outer sides relative to the transport roller unit 88, that is, opposite sides to the transport central position relative to the transport members 88a of the transport roller unit 88.

Furthermore, the leading end portion of the recording medium 100B having been introduced into the normal transport path 56a is temporarily stopped by the registration roller unit 58, and the recording medium 100B is fed toward the transfer device 24 at timing coincident with timing of image formation.

At this time, the memories 104 of the recording medium 100B pass through without being brought into contact with the transport members 58a of the registration roller unit 58. That is, as illustrated in FIG. 10, in the registration roller unit 58 of the normal transport path 56a, the positions where the memories 104 of the recording medium 100B are provided pass through portions between the transport members 58a of the registration roller unit 58.

Then, the image is formed on the recording medium 100B as described above, and after that, the recording medium 100B is output to the output unit 16. Thus, image formation is completed.

From the above description, according to the third exemplary embodiment, even with the recording medium 100B having no wide portion 126, the memories 104 of the recording medium 100B are able to be disposed at the positions where the memories 104 are to be brought into contact with neither the transport members 88a of the transport roller unit 88 nor the transport members 58a of the registration roller unit 58 of the normal transport path 56a by disposing the recording medium 100B together with the guide member 140B when disposing the recording medium 100B in the manual feed unit 80. Thus, problems such as damage to the memories 104 and the like may be prevented.

Furthermore, although only the circuit devices 102 are provided in the release portions 124 of the recording medium 100B according to the third exemplary embodiment, this is not limiting. As is the case with the first exemplary embodiment, the release portions 124 may each include the portion where the circuit device 102 is provided and the portion where the circuit device 102 is not provided. In this case, these portions are connected to each other at a region where the perforation 120 is provided.

A Fourth Exemplary Embodiment

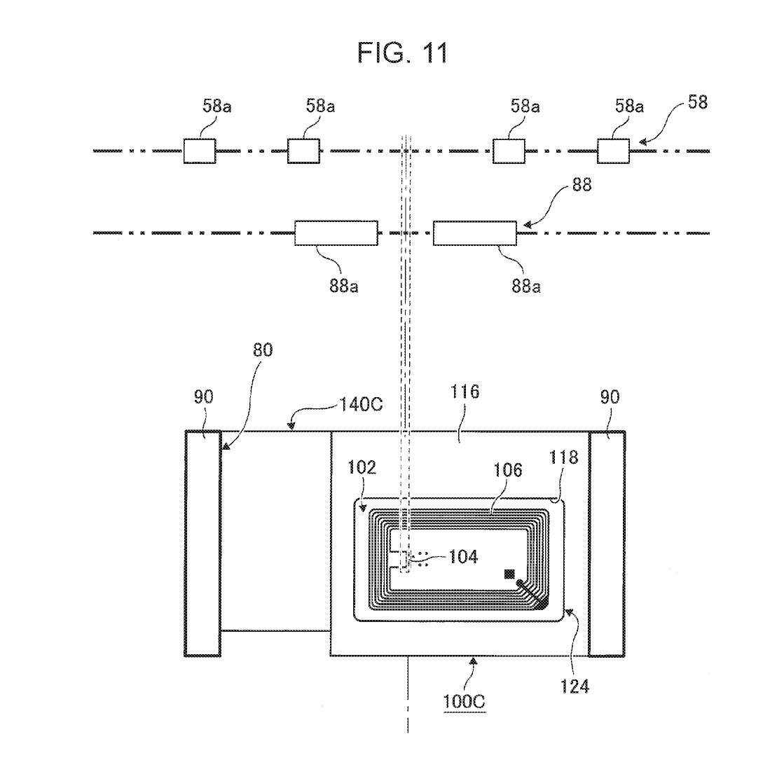

Next, the image forming apparatus 10, a recording medium 100C, and a guide member 140C according to a fourth exemplary embodiment are described with reference to FIGS. 1, 11, and so forth. The recording medium 100B according to the third exemplary embodiment includes two circuit devices 102 as is the case with the recording medium 100 according to the first exemplary embodiment. In addition, the guide member 140B is provided according to the third exemplary embodiment. The recording medium 100C according to the fourth exemplary embodiment includes a single circuit device 102 as is the case with the recording medium 100A according to the second exemplary embodiment. In addition, the guide member 140C is provided according to the fourth exemplary embodiment. It is noted that elements of the image forming apparatus 10 and the recording medium 100C according to the fourth exemplary embodiment which are the same as or similar to those of the image forming apparatus 10 according to the first exemplary embodiment and the recording media 100, 100A, and 100B according to the first to third exemplary embodiments are denoted by the same reference numerals, and detailed description thereof is omitted.

As illustrated in FIG. 11, the recording medium 100C according to the fourth exemplary embodiment is configured similarly to the recording medium 100A according to the second exemplary embodiment. However, unlike the recording medium 100A according to the second exemplary embodiment, no wide portion 126 is provided in the recording medium 100C and the size of the longitudinal side of the recording medium 100C is reduced compared to that of the recording medium 100A according to the second exemplary embodiment. Furthermore, the recording medium 100C according to the fourth exemplary embodiment has the same configuration as one of one recording medium 100Ba and another recording medium 100Bb disposed on one and the other sides of the recording medium 100B according to the third exemplary embodiment with the vertical perforation 122 interposed therebetween.

That is, the recording medium 100C according to the fourth exemplary embodiment is one of two recording media, that is, the one recording medium 100Ba and the other recording medium 100Bb of the recording medium 100B according to the third exemplary embodiment separated from each other by the vertical perforation 122. Thus, the recording medium 100C according to the fourth exemplary embodiment and, for example, the one recording medium 100Ba of the recording medium 100B according to the third exemplary embodiment have the same or similar configuration. Furthermore, as is the case with the recording medium 100A′ of the second application of the second exemplary embodiment, the release portion 124 of the recording medium 100C according to the fourth exemplary embodiment includes only the portion where the circuit device 102 is provided. Detailed description of the recording medium 100C according to the fourth exemplary embodiment is omitted.

Furthermore, according to the fourth exemplary embodiment, when the recording medium 100C is placed in the manual feed unit 80, the guide member 140C is also placed together with the recording medium 100C beside the recording medium 100C as is the case with the third exemplary embodiment. When the recording medium 100C and the guide member 140C are supported by the manual feed guides 90, the memory 104 is disposed at a position where the memory 104 is to be brought into contact with neither the transport members 88a of the transport roller unit 88 nor the transport members 58a of the registration roller unit 58 of the normal transport path 56a.

This guide member 140C has a predetermined width and is formed by a substantially rectangular parallelepiped block having a size that allows the recording medium 100C to be disposed at a position where the memory 104 of the recording medium 100C is to be brought into contact with neither the transport members 88a of the transport roller unit 88 nor the transport members 58a of the registration roller unit 58 of the transport path 56 (see FIG. 11). According to the fourth exemplary embodiment, the size of the guide member 140C is determined so that the memory 104 of the recording medium 100C is aligned with the transport central position of the normal transport path 56a.

Furthermore, in order to form an image on the recording medium 100C according to the fourth exemplary embodiment with the image forming apparatus 10, first, the recording medium 100C is placed in the manual feed unit 80. The guide member 140C and the recording medium 100C are disposed as follows: the guide member 140C is in contact with and supported by one of the manual feed guides 90 of the manual feed unit 80 which is located on the left side as illustrated in FIG. 11 according to the fourth exemplary embodiment; and the recording medium 100C is in contact with and supported by the other manual feed guide 90.

This is for disposing the memory 104 of the recording medium 100C according to the fourth exemplary embodiment such that the memory 104 is to be brought into contact with neither the transport members 88a of the transport roller unit 88 nor the transport members 58a of the registration roller unit 58. When the guide member 140C and the recording medium 100C are disposed on the opposite sides of the manual feed unit 80 to the respective sides described above, the memory 104 of the recording medium 100C may be to be brought into contact with the transport members 88a of the transport roller unit 88 or the transport members 58a of the registration roller unit 58. Furthermore, at this time, the memory 104 of the recording medium 100C is substantially aligned with the transport central position of the normal transport path 56a.

Furthermore, in order to clarify the orientation and the direction of transportation of the recording medium 100C, marks 130 such as arrows may be provided. Since the coating layer 108 where the image is formed faces downward in the manual feed unit 80, the marks 130 are formed on the surface of the release paper 116 side, which is the opposite side of the recording medium 100C to the coating layer 108 where the image is formed.

Furthermore, the recording medium 100C having been placed in the manual feed unit 80 is fed from the manual feed unit 80 into the image forming apparatus body 12. Due to this feeding, the recording medium 100C is fed by the manual feed pickup roller 82. Then, the recording medium 100C is separated from another recording medium 100C by the manual feed supply roller 84 and the manual feed retard roller 86 in the case where plural recording media 100C have been fed. Then, the recording medium 100C is introduced into the normal transport path 56a by the transport roller unit 88.

At this time, the memory 104 of the recording medium 100C passes through without being brought into contact with the transport members 88a of the transport roller unit 88. That is, as illustrated in FIG. 11, in the transport roller unit 88 of the normal transport path 56a, the position where the memory 104 of the recording medium 100C is provided passes through the space between the transport members 88a at the central portion of the transport roller unit 88.

Furthermore, the leading end portion of the recording medium 100C having been introduced into the normal transport path 56a is temporarily stopped by the registration roller unit 58, and the recording medium 100C is fed toward the transfer device 24 at timing coincident with timing of image formation.

At this time, the memory 104 of the recording medium 100C passes through without being brought into contact with the transport members 58a of the registration roller unit 58. That is, as illustrated in FIG. 11, in the registration roller unit 58 of the normal transport path 56a, the position where the memory 104 of the recording medium 100C is provided passes through the space between the transport members 58a at the central portion of the registration roller unit 58.

Then, the image is formed on the recording medium 100C as described above, and after that, the recording medium 100C is output to the output unit 16. Thus, image formation is completed.

From the above description, according to the fourth exemplary embodiment, even with the recording medium 100C having no wide portion 126, the memory 104 of the recording medium 100C is disposed at the position where the memory 104 is to be brought into contact with neither the transport members 88a of the transport roller unit 88 nor the transport members 58a of the registration roller unit 58 of the normal transport path 56a by disposing the recording medium 100C together with the guide member 140C when disposing the recording medium 100C in the manual feed unit 80. Thus, problems such as damage to the memory 104 and the like may be prevented.

Furthermore, although only the circuit device 102 is provided in the release portion 124 of the recording medium 100C according to the fourth exemplary embodiment, this is not limiting. As is the case with the second exemplary embodiment, the release portion 124 may include the portion where the circuit device 102 is provided and the portion where the circuit device 102 is not provided. In this case, these portions are connected to each other at a region where the perforation 120 is provided.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording medium comprising:
at least one memory,
wherein the at least one memory is provided at a position where the at least one memory is not to be brought into contact with at least one transport member included in at least one transport unit provided in a transport path of an image forming apparatus.

2. The recording medium according claim 1, further comprising:
one base material having a first adhesive layer; and
another base material having a second adhesive layer bonded to the first adhesive layer,
wherein the at least one memory is disposed between the first adhesive layer and the second adhesive layer,
wherein the recording medium has a cut that surrounds at least the at least one memory and that extends from a one base material side to the second adhesive layer in a depth direction of the recording medium,
wherein the cut has a first cut part and a second cut part which is closer to the at least one memory than the first cut part, and
wherein the recording medium has a wide portion that is used to adjust a position at which the at least one memory is transported through the transport path, that has a predetermined area, that extends in a direction perpendicular to a transport direction, and that is provided on an opposite side to the at least one memory with the second cut part interposed therebetween.

3. The recording medium according claim 2,
wherein the recording medium has a region that extends in the direction perpendicular to the transport direction and that exists on an opposite side to the at least one memory with the first cut part interposed therebetween, and
wherein the area of the wide portion is larger than an area of the region.

4. The recording medium according to claim 1,
wherein, out of a plurality of transport units provided in the transport path, the at least one transport unit includes the at least one transport member that applies a pressing force of larger than 10.0 kgf to at least the at least one memory during transportation of the at least one memory.

5. The recording medium according to claim 2,
wherein, out of a plurality of transport units provided in the transport path, the at least one transport unit includes the at least one transport member that applies a pressing force of larger than 10.0 kgf to at least the at least one memory during transportation of the at least one memory.

6. The recording medium according to claim 3,
wherein, out of a plurality of transport units provided in the transport path, the at least one transport unit includes the at least one transport member that applies a pressing force of larger than 10.0 kgf to at least the at least one memory during transportation of the at least one memory.

7. An image forming apparatus,
wherein the image forming apparatus has a transport path through which a recording medium that includes a memory is transported,
wherein the image forming apparatus includes
an image forming apparatus body, and
at least one transport unit that is provided in the transport path and that includes at least one transport member, and
wherein, when the recording medium is transported, the memory passes through a space where the at least one transport member is not disposed.

8. The image forming apparatus according to claim 7,
wherein the transport path has a central position,
wherein the recording medium has a central position of a width in a direction perpendicular to a transport direction of the recording medium,
wherein the image forming apparatus body includes an opening/closing device in which the recording medium is disposed and from which the recording medium is fed toward the transport path, and
wherein the opening/closing device includes a pair of guide portions that align the central position of the recording medium with the central position of the transport path.

9. A guide member,
wherein the guide member is disposed together with a recording medium in an opening/closing member which is provided in an image forming apparatus and in which the recording medium to be fed toward a transport path is placed, and
wherein a position of at least one memory included in the recording medium placed in the opening/closing member is adjusted so that the at least one memory is disposed at a position where the at least one memory is not to be brought into contact with at least one transport member included in at least one transport unit provided in the transport path of the image forming apparatus.
